(19) United States
(12) Patent Application Publication
(10) Pub. No.: US 2004/0255937 A1
(43) Pub. Date: Dec. 23, 2004

(54) Personal isolation apparatus for preventing infection of SARS or the like

(76) Inventor: En-Jang Sun, Taipei (TW)

Correspondence Address: En-Jang Sun, P.O. Box 55-846, Taipei, 104, TW

(21) Appl. No.: 10/600,873

(22) Filed: Jun. 18, 2003

(51) Int. Cl. A62B 7/10; A62B 19/00

(52) U.S. Cl. 128/201.25; 128/202.12

(57) ABSTRACT

A personal isolation apparatus includes: a hood for covering a patient's body; a filter device connected to the hood having filters for removing SARS virus or other microorganisms as laden in the air streamflow as sucked from the hood by an exhaust fan; and at least an ultraviolet lamp formed between the hood and the filter device for killing or destroying the SARS virus or other microorganisms as laden in the air streamflow as sucked from the hood, thereby preventing infection of SARS and other diseases as infected by the microorganisms.

### BACKGROUND OF THE INVENTION

A new virus called Severe Acute Respiratory Syndrome (SARS) virus was suspected to be derived from China in late 2002 and then spread worldwide. Since it is a new developed virus, no vaccine or medicine is available to cure or treat such a virus. The isolation to separate the SARS patient from the other people is the efficient way to prevent from infection or spreading of SARS virus.

U.S. Pat. No. 5,891,399 (issued in 1999) disclosed a cleaning arrangement including filters and ultraviolet radiation for purifying air in a room. It comprises a housing for positioning an ultraviolet light source in the housing, a pre-filter and a post-filter disposed on an upstream and a downstream of the UV light source for air purification. However, it is generally used in a big room, not suitable for personal isolation such as for isolating a SARS patient who is isolated and transferred from a patient's home to a hospital as carried by an ambulance.

The present inventor has found the necessity for personally isolating a patient and invented the present personal isolation apparatus.

### SUMMARY OF THE INVENTION

The object of the present invention is to provide a personal isolation apparatus including: a hood for covering a patient's body; a filter device connected to the hood having filters for removing SARS virus or other microorganisms as laden in the air streamflow as sucked from the hood by an exhaust fan; and at least an ultraviolet lamp formed between the hood and the filter device for killing or destroying the SARS virus or other microorganisms as laden in the air streamflow as sucked from the hood, thereby preventing infection of SARS and other diseases as infected by the related microorganisms.

### BRIEF DESCRIPTION OF THE DRAWINGS

FIG. 1 is a perspective view of the present invention.

FIG. 2 is a sectional drawing of the present invention.

FIG. 3 is a sectional drawing of the present invention as modified from FIG. 2.

FIG. 4 shows another modification of the present invention based on FIG. 2.

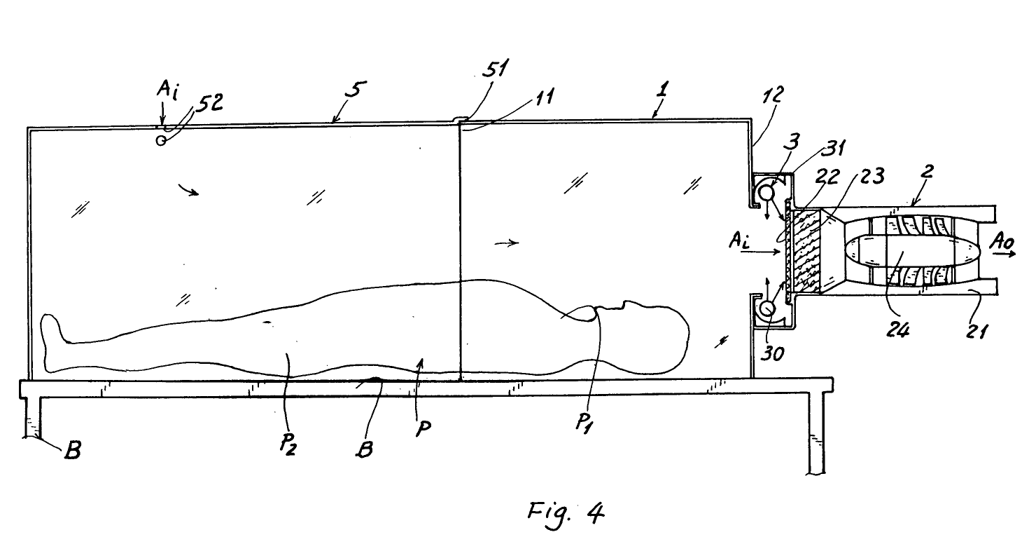

### DETAILED DESCRIPTION

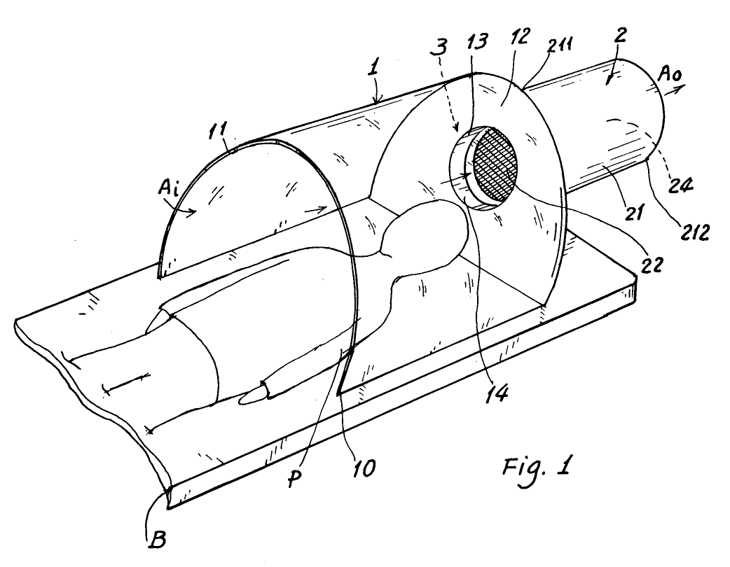

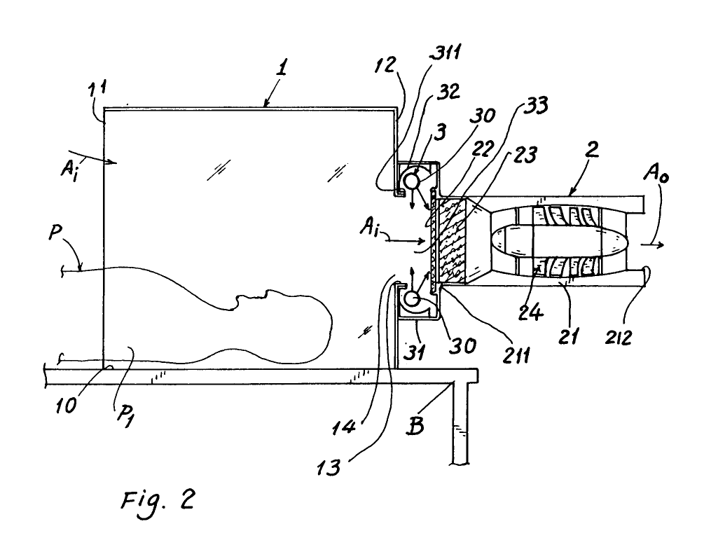

As shown in FIGS. 1 and 2, the personal isolation apparatus of the present invention comprises: a hood 1 for covering a patient P lying on a hospital bed or bed B; a filter device 2 securable to the hood 1; and an ultraviolet sterilizer 3 formed between the hood 1 and the filter device 2. The hood 1 may be formed to have a cross section of semi-circular shape, inversed U shape or other geometric forms, not limited in the present invention. It may be a transparent cover preferably made of polycarbonate (PC), acrylic, or other suitable materials.

The hood 1 includes: a base portion 10 laid on a bed B and preferably coated with a packing such as rubber packing on a bottom of the base portion 10, an inlet port 11 formed in an open front end of the hood 1 adjacent to a patient's chest allowing entrance of inlet air Ai into the hood, a rear end plate 12 opposite to the inlet port 11 formed on a rear closed end of the hood 1 adjacent to a patient's head, a connector 13 (such as a male connector) protruding rearwardly from the hood 1 to be detachably connected with the ultraviolet (UV) sterilizer 3 and the filter device 2, and a rear opening 14 defined within the connector 13 to allow air Ai to enter the UV sterilizer 3 and the filter device 2.

The filter device 2 includes: a duct 21 connected to the hood 1 or connected to the hood 1 through the UV sterilizer 3, a primary filter 22 formed in a front end portion (suction port) 211 of the duct 21 secured at a suction port 211 of the duct 21 for preliminarily filtering off the droplet as sprayed from the patient, a secondary filter 23 formed in the duct 21 following the primary filter 22 for further removing particulates or microparticles as laden in the inlet air stream Ai, and an exhaust fan 24 (preferably selected from axial-flow fan) formed in the duct 21 at a downstream of the secondary filter 23 for sucking air Ai from the hood 1 through the UV sterilizer 3 and the filters 22, 23 in the duct 21 and for discharging outlet air Ao through a discharge port 212 formed in a rearmost end of the duct 21.

The primary filter 22 may be made of non-woven cloth for filtering the droplets as sprayed from the patient.

The secondary filter 23 is a high-efficiency particulate air (HEPA) filter which is also made of non-woven cloth capable for removing 99.97% particles or microparticles including SARS virus. An activated carbon or other virus-removing agent may be incorporated in the secondary filter 23.

The primary and secondary filters 22, 23 are detachable from the duct 21 of the filter device 2 for a safe and hygienic disposal of the used filters without causing further infection or contamination to the environment or people. The hood 1, the filter device 2 and the cover of the UV sterilizer 3 should be repeatedly sterilized such as by using aqueous sodium hypochlorite solution or other disinfective agents.

The ultraviolet sterilizer 3 includes: at least an ultraviolet lamp 30 secured in a lamp cover 31 connected between the hood 1 and the filter device 2 for irradiation of UV light to the inlet air Ai entering an air passage 33 as defined in the sterilizer 3 and to the primary filter 22, and a reflector 32 formed on a back side of the UV lamp 30 for reflecting UV light as emitted from the UV lamp 30 towards the air passage 33 as defined within the UV lamp 30 and the lamp cover 31 of the sterilizer 3 and for reflecting UV light towards the primary filter 22 of the filter device 2.

The lamp cover 31 may also be integrally formed with the duct 21 of the filter device 2, namely by modifying a front portion of the duct 21 in order for providing the UV lamp 30 in the front portion in the duct 21.

The air is sucked by the exhaust fan 24 from the environment into the hood 1 wherein the patient's head is located to develop a negative pressure in the hood 1 to prevent from an outward spreading of the patient's droplet containing SARS virus or the like. The inlet air Ai is then irradiated by the UV lamp 30 through the passage 33 and then directed through the filters 22, 23 for filtering the droplets, virus or other pollutants as laden in the air streamflow.

The primary filter 22 is provided to filter off the patient's droplets, and the secondary filter 23 rendered to filter the particles up to 99.97%, almost completely removing the virus particulates as laden in the air streamflow.

So, the outlet air Ao as discharged through the port 212 of the duct 21 will be “purified”, without contaminating the environmental air.

Therefore, the present invention may be provided to isolate a SARS patient or a patient infected with infectious virus to prevent spreading of SARS and other infectious diseases.

By inverting the connection of the duct 21 to the hood 1 such as by connecting the port 212 to the connector 13 of the hood, a positive pressure may be developed in the interior in the hood by sucking air which has been filtered through the filters mounted in the duct 21 to supply purified air into the hood for a patient's normal breathing use if the patient is not a SARS patient but he (or she) is exposed to an atmosphere possibly being contaminated in a public room (e.g., a hospital).

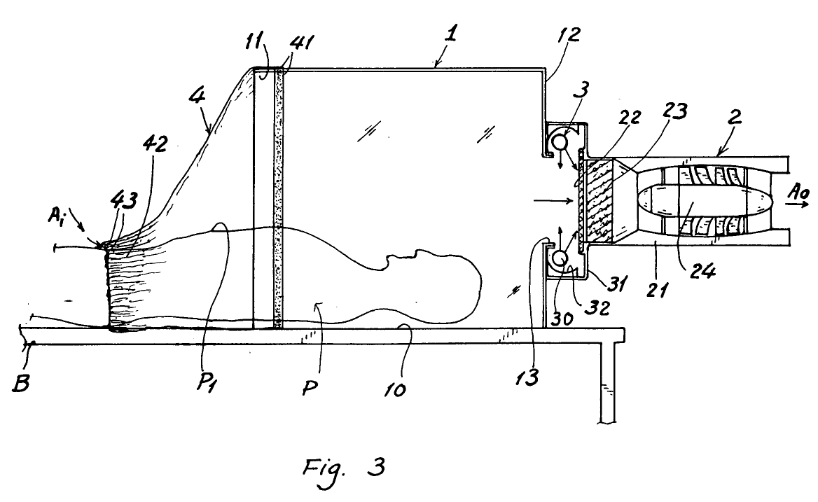

As shown in FIG. 3, an auxiliary cover 4 is provided to further shield the upper body portion PI of the patient. The auxiliary cover 4 includes a rear portion 41 fastened to the inlet port 11 of the hood 1 and a front portion 42 flexibly and foldably fastened to the patient's chest or waist portion, allowing a plurality of air inlet openings 43 formed between the cover 4 and the patient P.

As shown in FIG. 5, an auxiliary hood 5 is provided to connect the inlet port 11 of the hood 1 to cover a lower body portion P₂ of the patient P to thereby completely shield the patient within the hood 1 and the auxiliary hood 5 for preventing outward spreading of patient's droplet or virus as sprayed or released from the patient.

A plurality of ventilation holes 52 are formed in the auxiliary hood 5 to allow air to enter the hoods 5, 1 to be breathed by the patient. The ventilation holes 52 are preferably distally separated from the hood 1 at a proper distance.

The present invention may be modified without departing from the spirit and scope of the present invention. The present invention is not only provided for isolating SARS patients. It may also be used for isolating patients who are infected by other microorganisms or pollutants. The primary and secondary filters 22, 23 may also be combined to be a filter unit as secured to the hood 1.

I claim:

1. A personal isolation apparatus comprising:
a hood for covering a patient's body;
a filter device connected to the hood having an exhaust fan secured therein and having a plurality of filters operatively filtering SARS virus and microorganisms as laden in the air streamflow as sucked from the hood by said exhaust fan; and
an ultraviolet sterilizer including at least an ultraviolet lamp and formed between the hood and the filter device and operatively killing the SARS virus and microorganisms as leaden in the air streamflow as sucked from the hood.

2. A personal isolation apparatus according to claim 1, wherein said hood includes: a base portion laid on a bed, an inlet port formed in an open front end of the hood adjacent to a patient's chest and waist for entering inlet air into the hood, a rear end plate opposite to the inlet port formed on a rear closed end of the hood adjacent to a patient's head, a connector protruding rearwardly from the hood to be detachably connected with the ultraviolet sterilizer and the filter device, and a rear opening defined within the connector to be fluidically communicated with the UV sterilizer and the filter device.

3. A personal isolation apparatus according to claim 1, wherein said filter device includes: a duct connected to the hood through the UV sterilizer, a primary filter formed in a front end portion of the duct secured at a suction port of the duct for preliminarily filtering off the droplet as sprayed from the patient, a secondary filter formed in the duct following the primary filter for further removing microparticles as laden in the inlet air streamflow, and an exhaust fan formed in the duct at a downstream of the secondary filter for sucking an inlet air from the hood through the UV sterilizer and the filters in the duct and for discharging an outlet air through a discharge port formed in a rearmost end of the duct.

4. A personal isolation apparatus according to claim 3, wherein said primary filter is made of non-woven cloth for filtering the droplets as sprayed from the patient.

5. A personal isolation apparatus according to claim 3, wherein said secondary filter is a high-efficiency particulate air filter made of non-woven cloth for removing microparticles including SARS virus.

6. A personal isolation apparatus according to claim 5, wherein said secondary filter includes incorporation of activated carbon and virus-removing agent in the secondary filter.

7. A personal isolation apparatus according to claim 3, wherein said primary and secondary filters are detachable from the duct of the filter device for a safe and hygienic disposal of the filters when used without causing infection and contamination to the environment.

8. A personal isolation apparatus according to claim 1, wherein said ultraviolet sterilizer includes: at least one said ultraviolet lamp secured in a lamp cover connected between the hood and the duct of the filter device for irradiation of UV light to the inlet air entering an air passage defined in the sterilizer and to the primary filter, and a reflector formed on a back side of the UV lamp for reflecting UV light as emitted from the UV lamp towards the air passage and towards the primary filter of the filter device.

9. A personal isolation apparatus according to claim 8, wherein said lamp cover is integrally formed with the duct of the filter device.

10. A personal isolation apparatus according to claim 1, wherein said hood is connected with an auxiliary cover which is provided to further shield an upper body portion of the patient; said auxiliary cover having a rear portion thereof fastened to an inlet port of the hood and a front portion of the auxiliary cover flexibly and foldably fastened to a patient's chest or waist portion and having a plurality of air inlet openings formed between the auxiliary cover and the patient.

11. A personal isolation apparatus according to claim 1, wherein said hood is connected with an auxiliary hood which is connected to an inlet port of the hood to cover a lower body portion of the patient to completely shield the patient within the hood and the auxiliary hood for preventing outward spreading of patient's droplet and virus as sprayed and released from the patient.

12. A personal isolation apparatus according to claim 11, wherein said auxiliary hood includes a plurality of ventilation holes formed in the auxiliary hood to allow air to enter the auxiliary hood and the hood to be breathed by the patient.
